(19) United States
(12) Patent Application Publication
(10) Pub. No.: US 2025/0158321 A1
(43) Pub. Date: May 15, 2025

(54) CONNECTOR

(71) Applicant: Yazaki Corporation, Tokyo (JP)

(72) Inventor: Takatoshi SUZUKI, Shizuoka (JP)

(73) Assignee: Yazaki Corporation, Tokyo (JP)

(21) Appl. No.: 18/944,772

(22) Filed: Nov. 12, 2024

(30) Foreign Application Priority Data
Nov. 15, 2023 (JP) 2023-194515

(51) Int. Cl. H01R 13/58

(52) U.S. Cl. CPC H01R 13/582; H01R 2201/26

(57) ABSTRACT

A connector connected to an external connector has a plurality of terminals and an electric wire lead-out portion for leading out a plurality of electric wires connected to each of the terminals to the outside in a first direction of connection to the external connector, and the electric wire lead-out portion has an electric wire holder which holds each of the electric wires by clamping.

### CROSS REFERENCE TO RELATED APPLICATION

The present application is based on, and claims priority from the Japanese Patent Application No. 2023-194515, filed on Nov. 15, 2023, the entire contents of which are incorporated herein by reference.

### TECHNICAL FIELD

The disclosure relates to a connector.

### BACKGROUND

Conventionally, there are connectors in which a direction of connection to an external connector is different from a direction in which an electric wire is led out to the outside. JP2014-38793 A discloses technology related to a so-called L-shaped connector, which has a structure that absorbs vibration and in which the direction of connection to an external connector is orthogonal to the direction in which an electric wire is led out to the outside.

### SUMMARY OF THE INVENTION

In the L-shaped connector disclosed in JP2014-38793 A, even if an electric wire holder for holding a part of an electric wire extending in the direction of leading out to the outside by clamping is provided inside, there is little effect on the miniaturization of the connector is small. However, in the case of a so-called U-shaped connector in which the direction of connecting to the external connector and the direction of leading out the electric wire to the outside are the same, there is a concern that the size of the connector may be increased if an electric wire holder for holding a part of an electric wire extending in the orthogonal direction from each terminal is provided.

It is an object of the disclosure to provide a connector advantageous for miniaturization while ensuring vibration resistance.

A connector connected to an external connector according to an aspect of the disclosure includes a plurality of terminals and an electric wire lead-out portion for leading out a plurality of electric wires connected to each of the terminals to the outside in a first direction of connection to the external connector, and the electric wire lead-out portion has an electric wire holder for holding each of the electric wires by clamping.

According to the configuration above, it is possible to provide a connector advantageous for miniaturization while securing vibration resistance.

### BRIEF DESCRIPTION OF THE DRAWINGS

FIG. 1 is a perspective view of a connector according to an embodiment.

FIG. 2 is an exploded perspective view of a connector according to an embodiment.

FIG. 3 is a cross-sectional view of a connector cut along section III-III in FIG. 1.

FIG. 4A is a perspective view of an outer housing after a rear holder is attached.

FIG. 4B is a perspective view of the outer housing before the rear holder is attached.

FIG. 5 is a perspective view of the outer housing viewed in a direction different from FIG. 4B.

FIG. 6 is a perspective view of the outer housing in a direction different from FIG. 4A.

FIG. 7 is a perspective view of a rear cover in one embodiment.

FIG. 8 is a cross-sectional view of the connector cut along section VIII-VIII in FIG. 1.

### DETAILED DESCRIPTION OF THE INVENTION

Hereinafter, a connector according to each embodiment will be described in detail with reference to the drawings. The dimensional ratios in the drawings are exaggerated for the sake of explanation and may differ from the actual ratios.

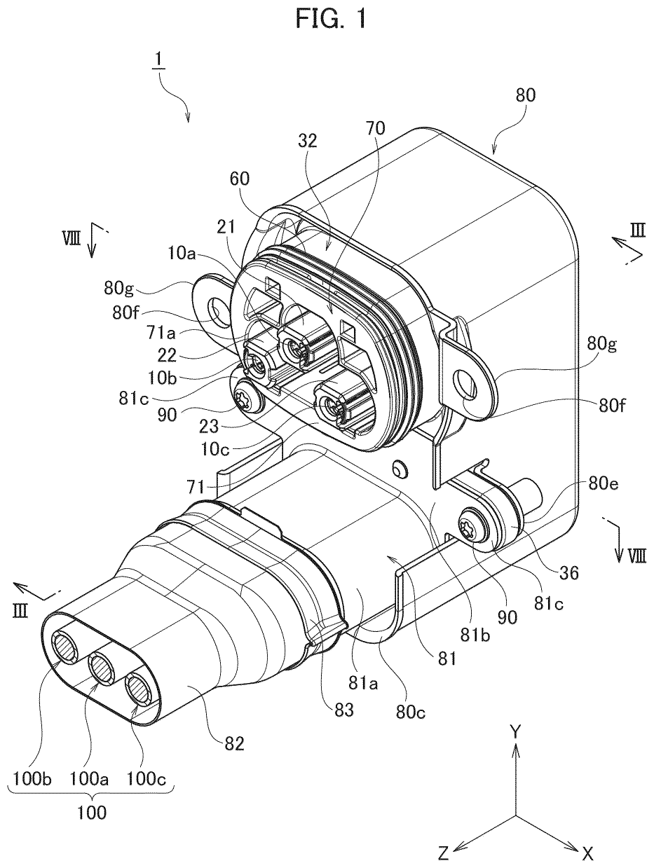

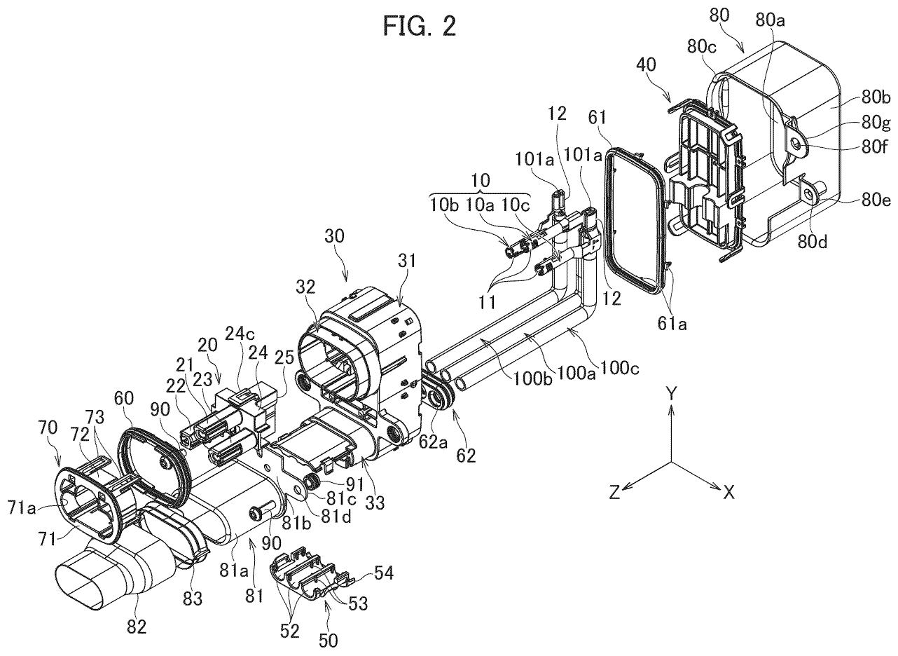

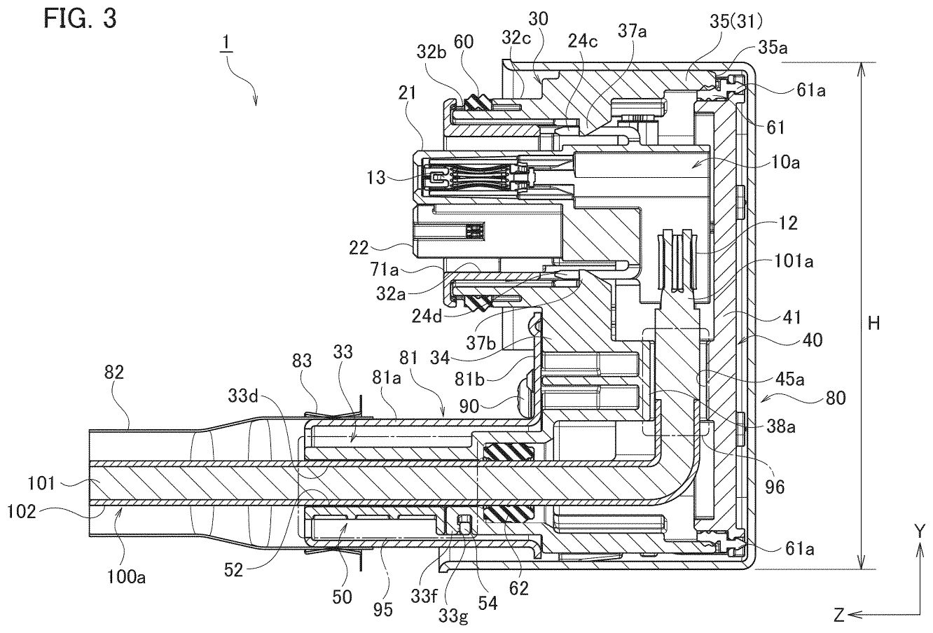

FIG. 1 is a perspective view of a connector 1 according to an embodiment. FIG. 2 is an exploded perspective view of the connector 1. FIG. 3 is a cross-sectional view of the connector 1 cut along section III-III in FIG. 1. The cut plane in FIG. 3 is an imaginary plane that passes through the center axis of a first terminal receptacle 21 and a first electric wire 100a, which will be described later.

The connector 1 is, for example, a high-voltage connector that can be employed in a power supply system of a rear motor mounted on an electric vehicle or a hybrid vehicle. In this embodiment, the connector 1 is attached to a power supply system of a three-phase motor (not shown) as a rear motor.

The power supply system of the three-phase motor includes three electric wires 100, that is, a first electric wire 100a, a second electric wire 100b, and a third electric wire 100c in advance. The first electric wire 100a is a U-phase electric wire. The second electric wire 100b is a V-phase electric wire. The third electric wire 100c is a W-phase electric wire. Each of the electric wires 100 has a core wire 101 which is a conductor and a covering 102 which is an insulator that covers the core wire 101. First terminals of the electric wires 100 are connected to a 3-phase motor, and the second terminals of the electric wires 100 are connected to the connector 1. At the second terminals connected to the connector 1, the covering 102 is removed, and terminal portions 101a of the core wire 101 are exposed. Although the core wire 101 may be composed of a plurality of wires, it is simply depicted as a single conductor member in the following drawings.

The connector 1 includes a plurality of terminals 10, an inner housing 20, an outer housing 30, a rear cover 40, and a rear holder 50 as a group of components related to electrical connection.

As the plurality of the terminals 10, in this embodiment, there are three terminals 10, that is, a first terminal 10a, a second terminal 10b, and a third terminal 10c, corresponding to the three-phase motor. The first terminal 10a is attached to a terminal of the first electric wire 100a. The second terminal 10b is attached to a terminal of the second electric wire 100b. The third terminal 10c is attached to a terminal of the third electric wire 100c.

Each of the three terminals 10 is a female terminal made of metal and has a connecting portion 11 and a crimping portion 12.

The connecting portion 11 is a cylindrical portion into which a rod-shaped male terminal can be freely inserted. The connecting portion 11 has a leaf spring member 13 for pressing a part of the male terminal against an inner wall of the connecting portion 11 in order to stably maintain a conductive state with the male terminal inserted therein. The leaf spring member 13 is installed in advance inside the connecting portion 11. The connecting portion 11 may have a leaf spring portion as a part of the connecting portion 11 in place of the leaf spring member 13.

The crimping portion 12 crimps the terminal portion 101a of the core wire 101. Assuming that one axial end of the connecting portion 11 is an open end into which a male terminal is inserted, the crimping portion 12 is integrated with the other axial end of the connecting portion 11. In this embodiment, the axial direction of the connecting portion 11 when the terminals 10 are installed in the connector 1 extends in the Z direction.

For each of the terminals 10, the direction from the crimping portion 12 toward the connecting portion 11 in the axial direction of the connecting portion 11 and the direction from the terminal portion 101a crimped to the crimping portion 12 toward bodies of the electric wires 100 are shifted by 90°. That is, when the terminals 10 are installed in the connector 1, the terminal portion 101a is crimped to the crimping portion 12 when the axial direction of the connecting portion 11 extends along the Z direction in a posture along the Y direction. At this point, each of the electric wires 100 extends from the terminal portion 101a in an opposite direction to the Y direction with the terminal portion 101a crimped to the crimping portion 12 as a starting point. The specific shape of the crimping portion 12 may be different for each of the three terminals 10. Further, in this embodiment, the terminals 10 has a crimping portion 12 to which the terminal portion 101a is crimped, but instead of the crimping portion 12, the terminal may have a plate-like joint to which the terminal portion 101a is joined by ultrasonic joining.

The inner housing 20 is made of a synthetic resin and is an insulating member for protecting the terminals 10 by holding the three terminals 10 therein. The inner housing 20 has a first terminal receptacle 21, a second terminal receptacle 22, a third terminal receptacle 23, a base 24, and a reinforcing structure 25.

The first terminal receptacle 21 is a cylindrical portion for receiving the connecting portion 11 of the first terminal 10a. The second terminal receptacle 22 is a cylindrical portion for receiving the connecting portion 11 of the second terminal 10b. The third terminal receptacle 23 is a cylindrical portion for receiving the connecting portion 11 of the third terminal 10c. The first terminal receptacle 21, the second terminal receptacle 22, and the third terminal receptacle 23 receive the connecting portion 11 so that the opening direction of the connecting portion 11 received therein, that is, an opposite direction to the direction in which the male terminal is inserted, is common as the direction in the first direction. In this embodiment, the first direction is the Z direction. End portions of the first terminal receptacle 21, the second terminal receptacle 22, and the third terminal receptacle 23 opens in the first direction and do not prevent the male terminal from entering the connecting portion 11.

As an example, the first terminal receptacle 21, the second terminal receptacle 22, and the third terminal receptacle 23 are arranged in two stages in the Y direction as a second direction defined below. For example, the first terminal receptacle 21 may be arranged in an upper stage in the second direction, and the second terminal receptacle 22 and the third terminal receptacle 23 may be arranged in a lower stage in the second direction. Then, in the X direction as a third direction defined below, the first terminal receptacle 21 may be arranged in an intermediate position between the second terminal receptacle 22 and the third terminal receptacle 23.

The base 24 is a flat plate for supporting the first terminal receptacle 21, the second terminal receptacle 22, and the third terminal receptacle 23. The base 24 supports root ends of the first terminal receptacle 21, the second terminal receptacle 22, and the third terminal receptacle 23 on the front side in the first direction. The internal spaces of the first terminal receptacle 21, the second terminal receptacle 22, and the third terminal receptacle 23 are opened in an opposite direction to the first direction on a back side in the first direction.

The base 24 has a first locking portion 24c and a second locking portion 24d arranged on opposite sides. An upper claw 37a and a lower claw 37b arranged facing each other are provided in a housing body 31 of the outer housing 30 described later. When the inner housing 20 is attached to the outer housing 30, the first locking portion 24c engages the upper claw 37a, and the second locking portion 24d engages the lower claw 37b, whereby the inner housing 20 is prevented from coming off from the outer housing 30.

The reinforcing structure 25 is a structure in which a plurality of reinforcing ribs are combined to ensure the strength of the inner housing 20. The reinforcing structure 25 is provided on the rear surface side of the base 24 so as not to interfere with the arrangement of each of the terminals 10 and each of the electric wires 100.

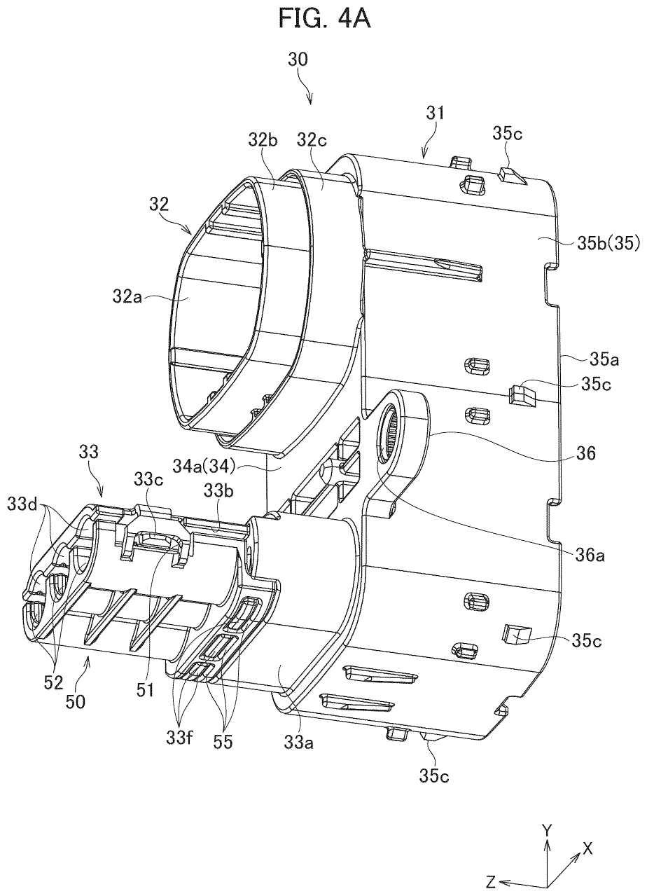

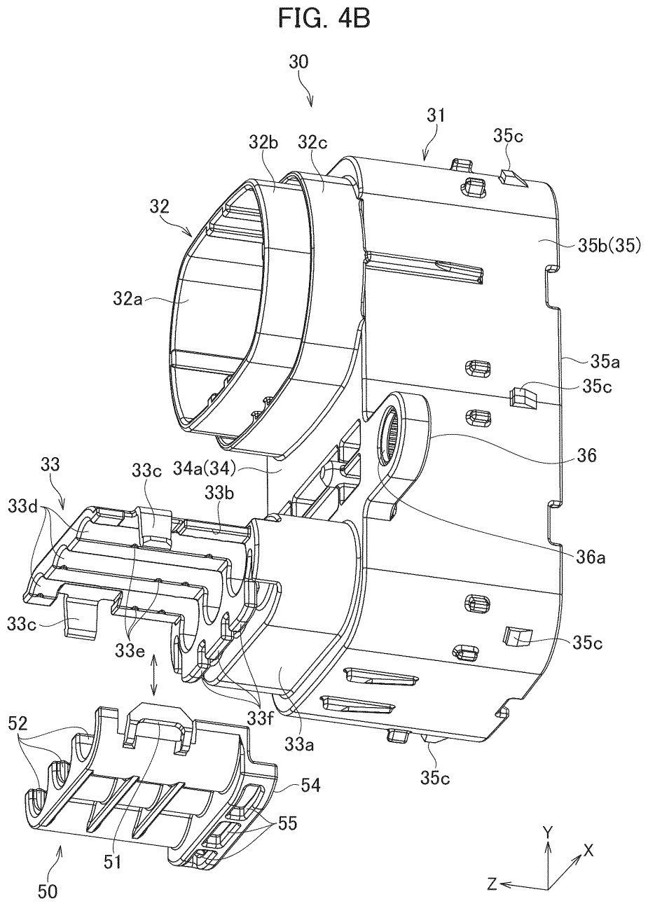

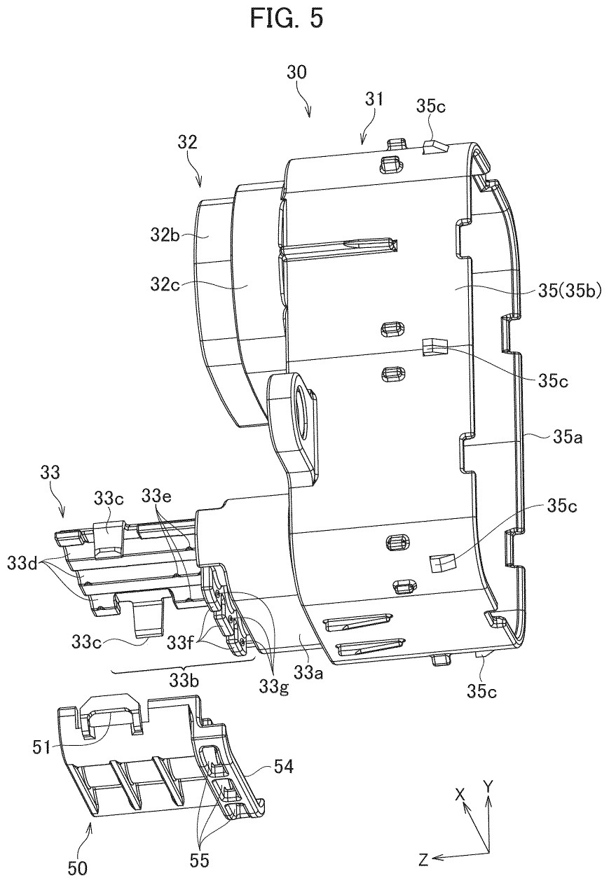

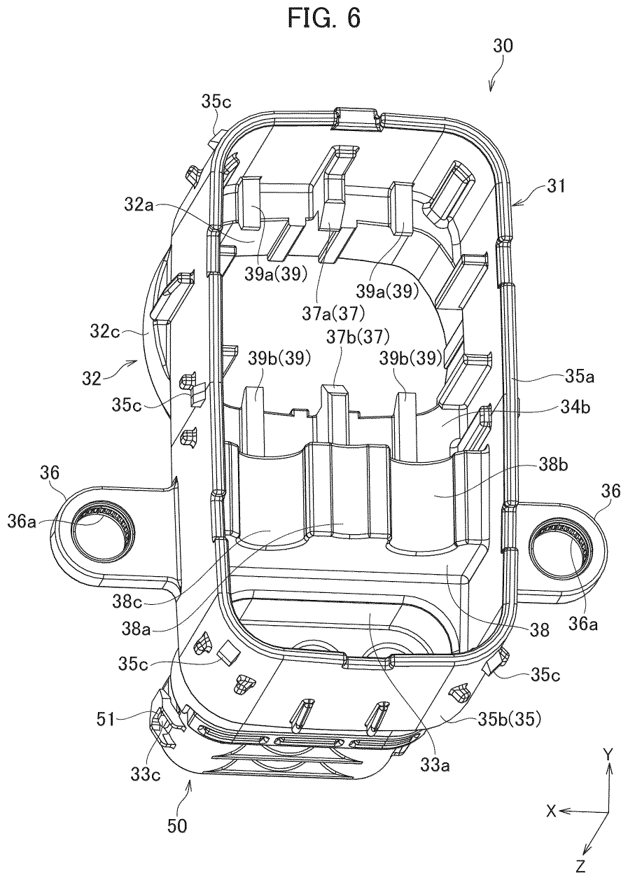

FIGS. 4A and 4B are a perspective view of the outer housing 30 and the rear holder 50 in the same direction. FIG. 4A illustrates a state after the rear holder 50 is attached to the outer housing 30. FIG. 4B illustrates a state in which the rear holder 50 is removed from the outer housing 30. FIG. 5 is a perspective view of the outer housing 30 and the rear holder 50 in another direction in the state in FIG. 4B. FIG. 6 is a perspective view of the outer housing 30 and the rear holder 50 in a direction in which the inner space can be visually recognized from an opening formed by an opening end 35a in another direction in the state in FIG. 4A.

The outer housing 30 is made of a synthetic resin and is an insulating member that protects the three terminals 10 as a whole by receiving at least a part of the inner housing 20 and the crimping portion 12 of each of the terminals 10. The outer housing 30 has the housing body 31, a connector shell 32, and an electric wire lead-out portion 33.

The housing body 31 is a box defined as follows: when the first direction is a length direction, the second direction orthogonal to the first direction is a height direction; and the third direction orthogonal to both the first direction and the second direction is a width direction. In this embodiment, the first direction is the Z direction, the second direction is the Y direction, and the third direction is the X direction, as described above. The housing body 31 has a front wall 34, an annular side wall 35, and a plurality of support pieces 36.

The front wall 34 is a wall perpendicular to the first direction, and supports the connector shell 32 and the electric wire lead-out portion 33 so as to be spaced apart from each other in the second direction by a first wall surface 34a. The plane of the front wall 34 has a substantially rectangular shape defined by a long side substantially in the second direction and a short side substantially in the third direction.

Further, the front wall 34 has a first electric wire facing portion 38 facing a second wall surface 34b that is spaced apart from a second electric wire facing portion 45 and faces the interior of the housing body 31 when the rear cover 40 described later is attached to the outer housing 30. The first electric wire facing portion 38 is a structure forming an electric wire guide 96 when combined with the second electric wire facing portion 45. The first electric wire facing portion 38 has a first facing groove 38a, a second facing groove 38b, and a third facing groove 38c, each of which has a second direction as an extension direction and includes a curved surface that matches a shape of side surfaces of the electric wires 100 routed inside the housing body 31. The first facing groove 38a receives a part of a side surface of the first electric wire 100a in a non-contact manner. The second facing groove 38b receives a part of a side surface of the second electric wire 100b in a non-contact manner. The third facing groove 38c receives a part of a side surface of the third electric wire 100c in a non-contact manner.

Moreover, the front wall 34 has a plurality of first engaging claws 37 provided on the second wall surface 34b across the shell 32a of the connector shell 32. In this embodiment, the plurality of the first engaging claws 37 are, as described above, the upper claw 37a and the lower claw 37b facing each other in the second direction. Similarly, the front wall 34 has a plurality of second engaging claws 39 provided on the second wall surface 34b across the shell 32a of the connector shell 32. The plurality of the second engaging claws 39 are, in this embodiment, two first upper claws 39a and two second lower claws 39b facing each other in the second direction.

The annular side wall 35, together with the front wall 34, forms an internal space that receives at least the crimping portion 12 of the terminals 10. One annular end of the annular side wall 35 in the first direction is continuous with a periphery of the front wall 34. The other annular end of the annular side wall 35 in the first direction is the opening end 35a that forms an opening facing the front wall 34. When the connector 1 is assembled, the three terminals 10 attached to the terminals of the electric wires 100 are received in the housing body 31 through openings formed by the opening end 35a. The annular side wall 35 has a plurality of engaging portions 35c provided on an outer wall surface 35b so as to be spaced apart from each other in a circumferential direction.

The support pieces 36 are provided on the outer wall surface 35b of the annular side wall 35 and have fitting holes 36a for fitting collars 91 to be described later. The fitting holes 36a penetrate the support pieces 36 in the first direction.

The connector shell 32 has the shell 32a having an elongated round cross section that opens in the first direction, and is a cylindrical portion that is fitted with a part of an external connector (not shown) when the external connector having a male terminal is connected to the connector 1. The connector shell 32 is provided so as to project in the first direction from the front wall 34 of the housing body 31. The shell 32a penetrates the inside of the housing body 31 from the outside of the outer housing 30, and can receive the inner housing 20. In the elongated round cross section of the shell 32a, the second direction is the longitudinal direction in accordance with the arrangement relationship of the first terminal receptacle 21, the second terminal receptacle 22, and the third terminal receptacle 23 in the inner housing 20.

The connector shell 32 has a first cylindrical portion 32b and a second cylindrical portion 32c which are continuous with each other in the first direction with the shell 32a as an inner wall. The first cylindrical portion 32b is a cylindrical portion which is positioned on a tip end side in the first direction, and to which a unit packing 60 described later is attached on an outer peripheral surface thereof. The second cylindrical portion 32c is a cylindrical portion which is positioned on a root side in the first direction. The second cylindrical portion 32c has an outer peripheral shape which is larger than an outer peripheral shape of the first cylindrical portion 32b, and faces at least a part of the unit packing 60 in the first direction when the unit packing 60 is attached to the first cylindrical portion 32b. Therefore, the unit packing 60 is restricted from moving toward the root side of the connector shell 32 by a certain amount or more.

The electric wire lead-out portion 33 is a structure for leading out the three electric wires 100 from the inside of the housing body 31 to the outside of the outer housing 30. The electric wire lead-out portion 33 has a cylindrical lead-out portion 33a and a first electric wire contact 33b.

The cylindrical lead-out portion 33a is provided to protrude in the first direction from the front wall 34 of the housing body 31, thereby forming a through-space with an elongated round cross section opening in the first direction. In the cross section of the through-space as the oblong hole, the second direction is the longitudinal direction so that the three electric wires 100 are arranged in the second direction in accordance with the arrangement relationship of the first terminal receptacle 21, the second terminal receptacle 22, and the third terminal receptacle 23 in the inner housing 20.

The first electric wire contact 33b is an end portion of the electric wire lead-out portion 33 which forms an electric wire holder 95 in combination with a rear holder 50 described later as a second electric wire contact. The overall schematic shape of the electric wire holder 95 is approximately a shape in which the cylindrical lead-out portion 33a is extended in the first direction. On the other hand, in this embodiment, the rear holder 50 is attached to the first electric wire contact 33b in the second direction corresponding to the Y direction. Therefore, a substantial shape of the first electric wire contact 33b is a shape in which the rear holder 50 is separated from the overall shape of the electric wire holder 95 with a virtual plane of the XZ plane as a reference. The first electric wire contact 33b has a plurality of holder engaging claws 33c, a plurality of first routing grooves 33d, a plurality of first holding ribs 33e, and holder engaging portions 33f.

In this embodiment, the plurality of the holder engaging claws 33c are provided at both ends of the first electric wire contact 33b in the third direction corresponding to the X direction. The holder engaging claws 33c are engaged with holder engaging portions 51 provided in the rear holder 50.

Each of the plurality of the first routing grooves 33d has a first direction as an extension direction, and the electric wires 100 led out from the cylindrical lead-out portion 33a are routed in the first direction. Each of the first routing grooves 33d includes a curved surface matching the side surface shape of each of the electric wires 100. In this embodiment, three electric wires 100 are led out from the cylindrical lead-out portion 33a, so that three first routing grooves 33d exist in parallel in the third direction.

The plurality of the first holding ribs 33e are provided for each of the first routing grooves 33d, and are caught by the covering 102 of the electric wires 100 routed in the first routing grooves 33d. The first holding ribs 33e provided for each of the first routing grooves 33d may be arranged with regularity while being spaced apart from each other, or may be arranged at random.

The holder engaging portions 33f are protruding portions that engage with holder locking holes 55 provided in the rear holder 50 when the rear holder 50 is attached to the first electric wire contact 33b. The three holder engaging portions 33f are provided in a region of the first electric wire contact 33b adjacent to the cylindrical lead-out portion 33a so as to face each end portion of the first routing grooves 33d in the third direction. Each of the holder engaging portions 33f has a shape of a flat plate with a projecting direction opposite the second direction and a main plane parallel to the XY plane.

The holder engaging portions 33f have engaging ribs 33g protruding in the first direction on at least one surface thereof. In this embodiment, as an example, the engaging ribs 33g provided on each of the three holder engaging portions 33f are directed in a opposite direction to the first direction, that is, from the first electric wire contact 33b toward to the cylindrical lead-out portion 33a.

In other words, according to the structure of the outer housing 30, in the connector 1, a direction in which the shell 32a of the connector shell 32 is directed, that is, a direction in which the connector is connected to the external connector, and a direction in which the three electric wires 100 are led out of the electric wire lead-out portion 33, are in the same direction. In this embodiment, the direction in which the shell 32a of the connector shell 32 is directed and the direction in which the three electric wires 100 are led out from the electric wire lead-out portion 33 are in the first direction corresponding to the Z direction.

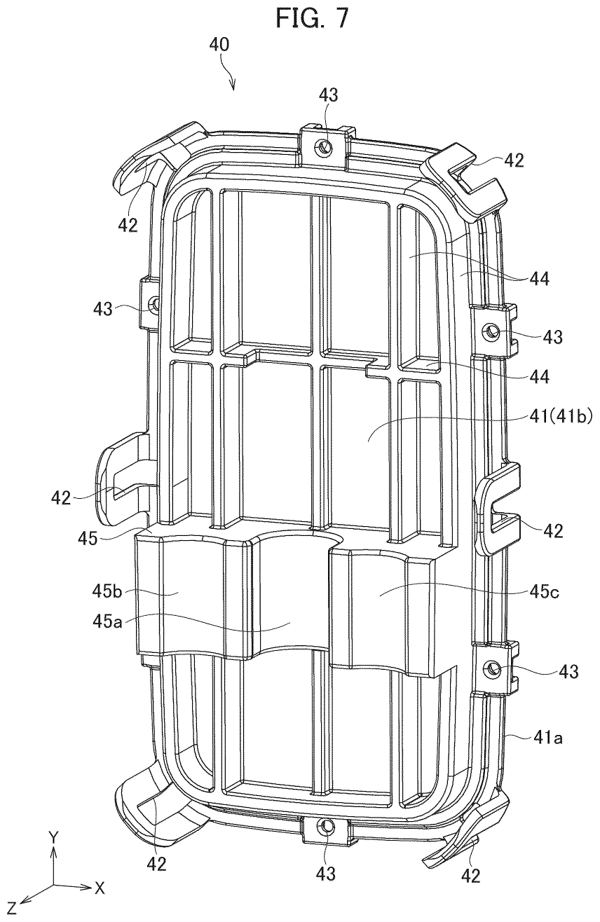

FIG. 7 is a perspective view of the rear cover 40 in a direction in which a side to be attached to the outer housing 30 can be visually recognized.

The rear cover 40 is made of a synthetic resin, and is an insulating member for covering an opening formed by the opening end 35a in a state that each of the terminals 10 formed by joining the terminal portion 101a to the crimping portion 12 is housed together with the terminal portion of the electric wires 100 in the housing body 31 of the outer housing 30. The rear cover 40 has a body wall 41, a plurality of locking portions 42, a plurality of packing-locking portions 43, a cover reinforcing rib 44, and the second electric wire facing portion 45.

The body wall 41 is a flat plate having an outer peripheral edge 41a along the opening end 35a of the housing body 31 when the rear cover 40 is attached to the outer housing 30. An inner wall surface 41b of the body wall 41 faces the front wall 34 of the housing body 31 when the rear cover 40 is attached to the outer housing 30.

The locking portions 42 are provided on the outer peripheral edge 41a of the body wall 41 at intervals from each other in a circumferential direction along the outer peripheral edge 41a. When the rear cover 40 is attached to the outer housing 30, each of the locking portions 42 prevents the rear cover 40 from coming off from the outer housing 30 by engaging one of the engaging portions 35c on the annular side wall 35.

The packing-locking portions 43 are provided on the outer peripheral edge 41a of the body wall 41 at intervals from each other in the circumferential direction along the outer peripheral edge 41a, avoiding the plurality of locking portions 42. A rear cover packing 61 described later is provided with a plurality of engaging projections 61a. Each of the packing-locking portions 43 engages one of the engaging projections 61a on the rear cover packing 61 when the rear cover 40 is attached to the outer housing 30.

In order to ensure the strength of the rear cover 40, the cover reinforcing rib 44 is provided on the inner wall surface 41b so as not to interfere with the arrangement of the terminals 10 and the electric wires 100.

The second electric wire facing portion 45 is provided on the inner wall surface 41b and faces the first electric wire facing portion 38 provided on the outer housing 30 at a distance when the rear cover 40 is attached to the outer housing 30. As described above, the second electric wire facing portion 45 is a structure forming the electric wire guide 96 when combined with the first electric wire facing portion 38. The second electric wire facing portion 45 has a first facing groove 45a, a second facing groove 45b, and a third facing groove 45c, each of which has a second direction as an extension direction and includes a curved surface matching a side surface shape of each of the electric wires 100 routed inside the housing body 31. The first facing groove 45a receives a part of the side surface of the first electric wire 100a in a non-contact manner. The second facing groove 45b receives a part of the side surface of the second electric wire 100b in a non-contact manner. The third facing groove 45c receives a part of the side surface of the third electric wire 100c in a non-contact manner.

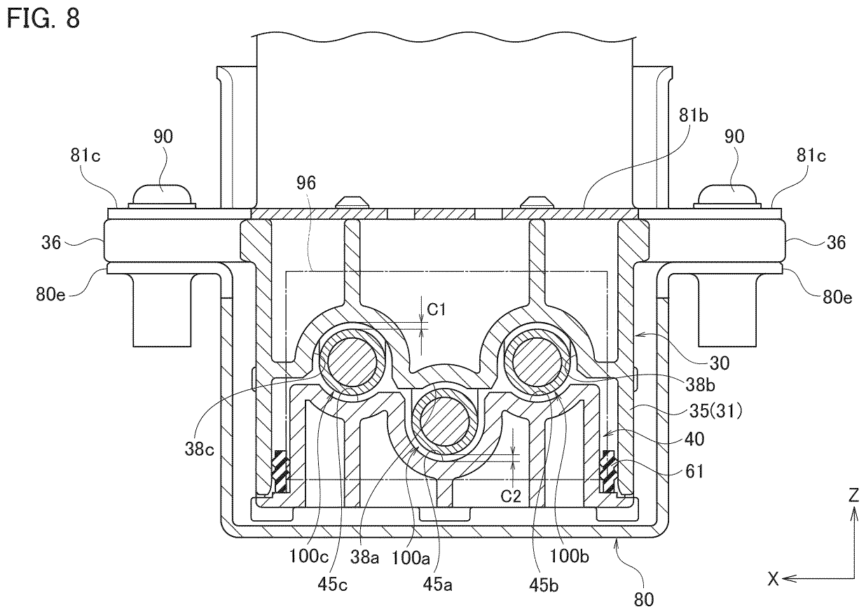

FIG. 8 is a cross-sectional view of the connector 1 cut at a section VIII-VIII in FIG. 1. The cut plane in FIG. 8 is an imaginary plane passing through a part of the electric wire guide 96.

When the rear cover 40 is attached to the outer housing 30, a part of the first electric wire 100a is held in a non-contact manner by the first facing groove 38a of the first electric wire facing portion 38 and the first facing groove 45a of the second electric wire facing portion 45. Similarly, the second electric wire 100b is held in a non-contact manner by the second facing groove 38b of the first electric wire facing portion 38 and the second facing groove 45b of the second electric wire facing portion 45. The third electric wire 100c is held in a non-contact manner by the third facing groove 38c of the first electric wire facing portion 38 and the third facing groove 45c of the second electric wire facing portion 45.

A distance between the facing grooves on the side of the first electric wire facing portion 38 and the side surfaces of the electric wires 100 facing the facing grooves is defined as a first distance C1. For example, a shortest distance between the first facing groove 38a of the first electric wire facing portion 38 and the side surface of the first electric wire 100a facing the first facing groove 38a is the first distance C1. Similarly, a distance between the facing grooves on the side of the second electric wire facing portion 45 and the side surface of the electric wires 100 facing the facing groove is defined as a second distance C2. For example, a shortest distance between the first facing groove 45a of the second electric wire facing portion 45 and the side surface of the first electric wire 100a facing the first facing groove 45a is the second distance C2.

When the position of the connector shell 32 with respect to the external connector is determined following the connection of the external connector on a male terminal side to the connector 1, the terminals 10 are aligned. Therefore, the first distance C1 and the second distance C2 are set in advance to the maximum alignment amount assumed when each of the terminals 10 is aligned following the connection of the external connector to the connector 1.

As described above, the rear holder 50 is a structural member that is attached to the first electric wire contact 33b of the electric wire lead-out portion 33 of the outer housing 30 and forms the electric wire holder 95 in combination with the first electric wire contact 33b. The rear holder 50 has a plurality of holder locking portions 51, a plurality of second routing grooves 52, a plurality of second holding ribs 53, and a holder locking-hole portion 54 in which holder locking holes 55 are formed.

In this embodiment, the holder locking portions 51 are provided at each end of the rear holder 50 in the third direction corresponding to the X direction. When the rear holder 50 is attached to the electric wire contact 33b, each of the holder locking portions 51 prevents the rear holder 50 from coming off the first electric wire contact 33b by engaging one of the holder engaging claws 33c in the first electric wire contact 33b.

Each of the second routing grooves 52 has the first direction as an extension direction, and routes the electric wires 100 led out from the cylindrical lead-out portion 33a in the first direction. Each of the second routing grooves 52 includes a curved surface matching the side surface shape of each of the electric wires 100. In this embodiment, three electric wires 100 are led out from the cylindrical lead-out portion 33a, whereby three of the second routing grooves 52 exist in parallel in the third direction. That is, when the rear holder 50 is attached to the first electric wire contact 33b, each of the second routing grooves 52 faces each of the first routing grooves 33d in the first electric wire contact 33b.

The second holding ribs 53 (see FIG. 2) are provided for each of the second routing grooves 52 and caught on the covering 102 of the electric wires 100 routed in the second routing grooves 52. Each of the second holding ribs 53 provided for each of the second routing grooves 52 may be spaced from each other and arranged with regularity, or may be arranged at random, as in the case of the first holding ribs 33e.

The holder locking-hole portion 54 is a structure in which a holder locking holes 55 are formed for fitting the holder engaging portions 33f provided on the first electric wire contact 33b when the rear holder 50 is attached to the first electric wire contact 33b. The opening shape and opening position of the holder locking holes 55 depend on the shape and arrangement of the holder engaging portions 33f in the first electric wire contact 33b. In this embodiment, there are three holder engaging portions 33f, and each of the holder engaging portions 33f has a shape of a flat plate. Therefore, three holder locking holes 55 are formed in the holder locking-hole portion 54. The opening shape of the holder locking holes 55 is rectangular in accordance with the cross-sectional shape of the holder engaging portions 33f. In particular, in this embodiment, the holder engaging portions 33f has the engaging ribs 33g. Therefore, when the holder engaging portions 33f are inserted into the holder locking holes 55, each of the engaging ribs 33g and the side surface of the holder engaging portions 33f on the opposite side of the engaging ribs 33g comes into close contact with the holder locking-hole portion 54.

Here, when the rear holder 50 is attached to the outer housing 30 with the three electric wires 100 led out from the cylindrical lead-out portion 33a, a part of electric wires 100 is clamped between one of the first routing grooves 33d and one of the second routing grooves 52. The first routing grooves 33d are provided with a plurality of first holding ribs 33e, and similarly, the second routing grooves 52 are provided with a plurality of second holding ribs 53. That is, the electric wire holder 95 holds each of the electric wires 100 by clamping more closely, whereby vibration transmitted from the outside through the electric wires 100 is suppressed from reaching the terminals 10.

Further, the connector 1 includes the unit packing 60, the rear cover packing 61, and the wire packing 62 as waterproof members for preventing moisture from entering the outer housing 30 from the outside.

The unit packing 60 is an annular elastic member closely attached to the outer peripheral surface of the connector shell 32 in the outer housing 30. The unit packing 60 seals a space between an outer peripheral surface of the connector shell 32 and a fitting surface of an external connector when the external connector is connected to the connector 1.

The rear cover packing 61 is an annular elastic member closely attached to the opening end 35a of the housing body 31 in the outer housing 30. When the rear cover 40 is attached to the outer housing 30, the rear cover packing 61 seals a space between the opening end 35a of the housing body 31 and the outer peripheral edge 41a of the rear cover 40.

The wire packing 62 is an elastic member in the shape of a long round flat plate that is closely attached to the inner wall surface of the cylindrical lead-out portion 33a of the electric wire lead-out portion 33 in the outer housing 30. The wire packing 62 has three through-holes 62a through which the electric wires pass in close contact with the through-holes 62a. The wire packing 62 seals a space between an inner wall surface of the cylindrical lead-out portion 33a and the electric wires 100 passing through a through-space of the cylindrical lead-out portion 33a.

The connector 1 further includes a front holder 70 as a holding member for the unit packing 60.

The front holder 70 is made of a synthetic resin and is attached to the outer housing 30 to prevent the unit packing 60 from coming off the connector shell 32. The front holder 70 has a front plate 71, a cylindrical portion 72, and a plurality of locking portions 73.

The front plate 71 is a flange-like annular plate positioned at an end of the connector shell 32 when the front holder 70 is attached to the outer housing 30. The front plate 71 has an opening 71a for exposing the first terminal receptacle 21, the second terminal receptacle 22, and the third terminal receptacle 23 of the inner housing 20 to the outside from the connector shell 32. When the front holder 70 is attached to the outer housing 30, at least a part of the outer periphery of the front plate 71 faces at least a part of the unit packing 60 attached to the connector shell 32 in the first direction. Therefore, even if the unit packing 60 moves toward the end of the connector shell 32, further movement is restricted by abutting on the front plate 71, so that the unit packing is prevented from coming off the connector shell 32.

The cylindrical portion 72 is received in the shell 32a of the connector shell 32 when the front holder 70 is attached to the outer housing 30. One opening end of the cylindrical portion 72 is a fixing end continuous with the opening 71a of the front plate 71. The other opening end of the cylindrical portion 72 is an open end toward the interior of the housing body 31 when the front holder 70 is attached to the outer housing 30. A reinforcing structure for securing the strength of the front holder 70 may be provided in the cylindrical portion 72.

The locking portions 73 are provided in a part of the cylindrical portion 72 so as to be spaced apart from each other in the circumferential direction. As described above, two first upper claws 39a and two second lower claws 39b are provided inside the housing body 31 of the outer housing 30. When the front holder 70 is attached to the outer housing 30, one of the locking portions 73 engages the first upper claw 39a, and another one of the locking portions 73 engages the second lower claw 39b, whereby the front holder 70 is prevented from coming off from the outer housing 30.

Further, the connector 1 includes an upper shell 80, a lower shell 81, a shield braid 82, and a shield ring 83 as shield members for shielding noise.

The upper shell 80 is made of metal and covers the housing body 31 of the outer housing 30 with the rear cover 40 attached thereto. The upper shell 80 may cover at least a part of the connector shell 32 or the electric wire lead-out portion 33 of the outer housing 30 while receiving the housing body 31. The upper shell 80 is a box defined as having the first direction corresponding to the Z direction as a length direction, the second direction corresponding to the Y direction as a height direction, and the third direction corresponding to the X direction as a width direction. The upper shell 80 has a bottom wall 80a, an annular side wall 80b, a plurality of first support pieces 80e, and a plurality of second support pieces 80g.

The bottom wall 80a is a wall orthogonal to the first direction. The planar shape of the bottom wall 80a is a substantially rectangular shape defined by a long side substantially in the second direction and a short side substantially in the third direction.

The annular side wall 80b, together with the bottom wall 80a, forms an internal space for receiving the housing body 31. One annular end of the annular side wall 80b in the first direction is continuous with a periphery of the bottom wall 80a. The other annular end of the annular side wall 80b in the first direction is an opening end 80c forming an opening facing the bottom wall 80a. When the connector 1 is assembled, the housing body 31 to which the rear cover 40 is attached is received from the opening formed by the opening end 80c.

The first support pieces 80e are portions, for example, provided by bending a part of the annular side wall 80b, and have a first through-hole 80d through which bolts 90 passing through the fitting holes 36a provided in the outer housing 30 pass when the connector 1 is assembled.

The second support pieces 80g are portions, for example, provided by bending a part protruding from the opening end 80c of the annular side wall 80b, and has a second through-hole 80f through which a mounting bolt (not shown) passes when the connector 1 is attached to the housing of the external connector.

The lower shell 81 is made of metal and covers a part of the front wall 34 of the housing body 31 of the outer housing 30 and the electric wire lead-out portion 33. The lower shell 81 has a cylindrical portion 81a, a flange 81b, and a support piece 81c.

The cylindrical portion 81a covers the electric wire lead-out portion 33 by receiving the electric wire lead-out portion 33 through a through-space having a round, elongated hole in cross section and opening in the first direction. One open end of the cylindrical portion 81a is a fixing end continuous with the flange 81b. The other open end of the cylindrical portion 81a is an open end forming an opening for leading out each of the electric wires 100 from the electric wire lead-out portion 33.

The flange 81b, which is a flat plate orthogonal to the first direction, faces a part of the front wall 34 to cover a part of the front wall 34.

The support piece 81c is provided as a portion protruding outward from an edge of the flange 81b, and has a through-hole 81d through which the bolts 90 pass before passing through the fitting holes 36a provided in the outer housing 30 when the connector 1 is assembled.

The shield braid 82 is a metallic braid, a part of which covers an end portion of the cylindrical portion 81a, and another part of which is wound so as to integrally cover the three electric wires 100 led out from the cylindrical portion 81a.

The shield ring 83 is a metallic fastening member for crimping the shield braid 82 to an outer peripheral surface of the cylindrical portion 81a of the lower shell 81.

Further, the connector 1 includes a plurality of the bolts 90 and a plurality of the collars 91 in an annular shape previously fitted into the fitting holes 36a of the outer housing 30 as members for assembling the components. As described above, the support piece 81c of the lower shell 81 is provided with the through-hole 81d. The collars 91 are fitted into the fitting holes 36a of the outer housing 30. The first support pieces 80e of the upper shell 80 are provided with a first through-hole 80d. The bolts 90 are fastened through the through-hole 81d, the collars 91 of the fitting holes 36a, and the first through-hole 80d, whereby the lower shell 81, the outer housing 30, and the upper shell 80 are integrally assembled.

Next, the operation and effect of the connector 1 will be described.

The connector 1 is connected to an external connector and has the plurality of the terminals 10, and the electric wire lead-out portion 33 for leading out the plurality of electric wires 100 connected to each of the terminals 10 to the outside in a first direction of connection to the external connector. The electric wire lead-out portion 33 has the electric wire holder 95 which holds each of the electric wires 100 by clamping.

Here, the first direction corresponds to the Z direction in the example described above.

First, the connector 1 is provided with the electric wire holder 95, so that, when the connector 1 is mounted on a vehicle, it is possible to avoid in advance a phenomenon in which vibration generated during vehicle travel is transmitted to the terminals 10 through the electric wires 100, and resistance rises due to wear of a contact.

On the other hand, when the external connector is connected to the connector 1, and the position of the connector shell 32 with respect to the external connector is determined, each of the terminals 10 is aligned. At this point, a repulsive force is generated in the electric wires 100 connected to each of the terminals 10.

As a comparative example, a so-called L-shaped connector is assumed in which a plurality of electric wires are led out in the second direction orthogonal to the first direction, unlike the configuration in this embodiment. The second direction corresponds to the Y direction according to the example described above. In such an L-shaped connector, it is possible to set an electric wire holder to hold a part of the electric wires 100 extending in the second direction by clamping, and as a result, there is little influence on the miniaturization of the connector. On the other hand, the situation is different in the case of a so-called U-shaped connector, such as the connector 1 according to this embodiment, in which both the direction of connection to the external connector and the direction of leading out the electric wires to the outside extend in the first direction. That is, when the electric wire holder is set to hold a part of the electric wires 100 extending in the second direction, the height H illustrated in FIG. 3 is assumed to be increased, and as a result, the size of the connector can be increased.

On the other hand, in the connector 1 according to this embodiment, the electric wire holder 95 to hold each of the electric wires 100 by clamping is provided in the electric wire lead-out portion 33 to lead out the electric wires 100 to the outside in the first direction. Therefore, in the connector 1, there is no need to provide the electric wire holder to clamp a part of the electric wires 100 extending in the second direction. Therefore, in the connector 1, there is no need to set the height H long, which is advantageous for miniaturization of the connector 1.

Further, a distance from each of the terminals 10 to the electric wire holder 95 is longer than a distance to the electric wire holder when a part of the electric wires 100 extending in the second direction is held by clamping. Therefore, in the electric wire holder 95, the repulsive force generated in the electric wires 100 can be made lower.

As described above, according to this embodiment, it is possible to provide the connector 1 advantageous to miniaturization while ensuring vibration resistance.

In the connector 1, the electric wire holder 95 may be a combination of the first electric wire contact 33b and the second electric wire contact. The first electric wire contact 33b may have a plurality of the first routing grooves 33d each having the first holding ribs 33e in contact with the electric wires 100 in accordance with each of the electric wires 100. The second electric wire contact may have a plurality of second routing grooves 52 having second holding ribs 53 facing each of the first routing grooves 33d and in contact with the electric wires 100.

Here, the second electric wire contact corresponds to a rear holder 50 in the example described above.

With the connector 1, each of the electric wires 100 is press-fitted into the electric wire holder 95, so that the electric wires 100 can be securely held. Further, the first electric wire contact 33b and the second electric wire contact can be freely attached and detached, so that it is advantageous in terms of improving workability when assembling the connector 1.

In the connector 1, the first electric wire contact 33b may have engaging portions. The second electric wire contact may have a locking-hole portion for fitting the engaging portions.

Here, the engaging portion corresponds to the holder engaging portions 33f in the example described above. The engaging hole corresponds to the holder locking-hole portion 54 in the example described above.

With the connector 1, when the first electric wire contact 33b and the second electric wire contact are combined to clamp the electric wires 100, the engaging portion is engaged with the locking-hole portion, thereby eliminating backlash between the first electric wire contact 33b and the second electric wire contact. Therefore, even if vibration is applied to the electric wires 100, it is possible to avoid a phenomenon that vibration of the electric wires 100 is transmitted to a downstream side due to displacement of one of the first electric wire contact 33b and the second electric wire contact with respect to the other.

In the connector 1, the engaging portions may have engaging ribs 33g protruding in a direction perpendicular to the direction in which the engaging portions are fitted into the locking-hole portion. The engaging ribs 33g may contact the locking-hole portion when the engaging portions is fitted into the locking-hole portion.

Here, the engaging portions corresponds to the holder engaging portions 33f in the example described above. The locking-hole portion corresponds to the holder locking-hole portion 54 in the example described above. In this case, the direction in which the engaging portion is fitted into the locking-hole portion corresponds to the opposite direction to the Y direction. The direction orthogonal to the direction in which the engaging portion is fitted into the locking-hole portion corresponds to the opposite direction to the Z direction.

With the connector 1, when the engaging portion is fitted into the locking-hole portion, a close contact between the engaging portion and the locking-hole portion can be further improved by bringing the engaging rib 33g provided in the engaging portion into contact with the locking-hole portion, so that the transmission of vibration from the electric wires 100 can be further suppressed.

Further, the connector 1 may include the first electric wire facing portion 38 and the second electric wire facing portion 45, which clamp each of the electric wires 100 extending in the second direction orthogonal to the first direction between each of the terminals 10 and the electric wire lead-out portion 33 in a non-contact manner. At least one of the first electric wire facing portion 38 and the second electric wire facing portion 45 may have a curved surface adapted to the side surfaces of the electric wires 100. The shortest distance between the first electric wire facing portion 38 and the side surfaces of the electric wires 100 facing the first electric wire facing portion 38 is the first distance C1, and the shortest distance between the second electric wire facing portion 45 and the side surfaces of the electric wires 100 facing the second electric wire facing portion 45 is the second distance C2. In this case, the first distance C1 and the second distance C2 may be set to the maximum alignment amount assumed when each of the terminals 10 is aligned following the connection of the external connector.

Here, the first direction corresponds to the Z direction in the example described above. The second direction corresponds to the Y direction in the example described above.

In the connector 1, the first electric wire facing portion 38 and the second electric wire facing portion 45 are provided between each of the terminals 10 and the electric wire lead-out portion 33, at least one of which has a curved surface adapted to the side surface of the wires 100 and holds each of the electric wires 100 in a non-contact manner. Therefore, when the terminals 10 are aligned, the electric wires 100 extending from each of the terminals 10 in the second direction are guided so as not to interfere with each other. Thus, it is possible to prevent the generation of a repulsive force in the electric wires 100 due to interference between the electric wires 100 adjacent to each other. Further, in the connector 1, the first distance C1 and the second distance C2 are set to the maximum alignment amount assumed when the terminals 10 are aligned, so that a necessary minimum value is obtained, which is advantageous for miniaturization of the connector 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A connector connected to an external connector, comprising:
a plurality of terminals; and
an electric wire lead-out portion for leading out a plurality of electric wires connected to each of the terminals to the outside in a first direction of connection to the external connector;
wherein the electric wire lead-out portion has an electric wire holder which holds each of the electric wires by clamping.

2. The connector according to claim 1,
wherein the electric wire holder is a combination of a first electric wire contact and a second electric wire contact;
wherein the first electric wire contact has a plurality of first routing grooves each having a first holding rib in contact with the electric wires in accordance with each of the electric wires; and
wherein the second electric wire contact has a plurality of second routing grooves having second holding ribs facing each of the first routing grooves and in contact with the electric wires.

3. The connector according to claim 2,
wherein the first electric wire contact has an engaging portion; and
wherein the second electric wire contact has a locking-hole portion for fitting the engaging portion.

4. The connector according to claim 3,
wherein the engaging portions have engaging ribs protruding in a direction perpendicular to a direction in which the engaging portions are fitted into the locking-hole portion; and
wherein the engaging ribs contact the locking-hole portion when the engaging portions are fitted into the locking-hole portion.

5. The connector according to claim 1, further comprising:
a first electric wire facing portion and a second electric wire facing portion, which clamp each of the electric wires extending in a second direction orthogonal to the first direction between each of the terminals and the wire lead-out portion in a non-contact manner;
wherein at least one of the first electric wire facing portion and the second electric wire facing portion has a curved surface adapted to side surfaces of the electric wires; and
wherein, when a shortest distance between the first electric wire facing portion and the side surfaces of the electric wires facing the first electric wire facing portion is a first distance, and a shortest distance between the second electric wire facing portion and the side surfaces of the electric wires facing the second electric wire facing portion is a second distance, the first distance and the second distance are set to the maximum alignment amount assumed when each of the terminals is aligned following the connection of the external connector.
